(19) United States
(12) Patent Application Publication
(10) Pub. No.: US 2014/0164981 A1
(43) Pub. Date: Jun. 12, 2014

(54) TEXT ENTRY

(71) Applicant: NOKIA CORPORATION, Espoo (FI)

(72) Inventors: Ashley Colley, Oulu (FI); Janne Kyllonen, Haukipudas (FI)

(73) Assignee: NOKIA CORPORATION, Espoo (FI)

(21) Appl. No.: 13/711,114

(22) Filed: Dec. 11, 2012

(51) Int. Cl. G06F 3/0481

(52) U.S. Cl. CPC G06F 3/0481
USPC 715/780

(57) ABSTRACT

An apparatus comprising:
at least one processor; and
at least one memory including computer program code,
the at least one memory and the computer program code configured, with the at least one processor, to cause the apparatus to perform at least the following:
enable presentation of control elements on a graphical user interface during text entry based on a text string entered into a text entry field, the control elements being associated with non-predictive-text functions.

### TECHNICAL FIELD

The present disclosure relates to the field of text entry. Certain disclosed example aspects/embodiments relate to portable electronic devices, in particular, so-called hand-portable electronic devices which may be hand-held in use (although they may be placed in a cradle in use). Such hand-portable electronic devices may include so-called Personal Digital Assistants (PDAs) and tablet PCs.

The portable electronic devices/apparatus according to one or more disclosed example aspects/embodiments may provide one or more audio/text/video communication functions (e.g. tele-communication, video-communication, and/or text transmission, Short Message Service (SMS)/Multimedia Message Service (MMS)/emailing functions, interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

It is common for electronic devices to provide a user interface (e.g. a graphical user interface). A user interface may enable a user to interact with an electronic device, for example, to open applications using application icons, enter commands, to select menu items from a menu, or to enter characters using a virtual keypad. To enter text strings, the user may be provided with a physical or virtual keyboard.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

According to a first example embodiment, there is provided an apparatus comprising:
at least one processor; and
at least one memory including computer program code,
the at least one memory and the computer program code configured, with the at least one processor, to cause the apparatus to perform at least the following:
enable presentation of control elements on a graphical user interface during text entry based on a text string entered into a text entry field, the control elements being associated with non-predictive-text functions.

Text entry may comprise entering a text string into a text field (e.g. using a keyboard or keypad). Text entry may be performed in response to a user selecting a series of one or more user interface elements (e.g. keys and/or predictive text candidate icons). The duration of text entry may start after the entering of the first character of a text string and continue whilst the user can enter further text (e.g. when a plurality of characters have been entered).

The presentation of the control elements may be based on the particular text string entered (i.e. the particular series of characters making up the text string). The presentation of the control elements may be based on the length of the particular text string entered. For example, when entering a telephone number, the device may be configured to present control elements, such as ‘dial number’ or send ‘text message’, when the number of numeric characters entered corresponds with the standard telephone number length in that area (e.g. 10 numeric characters for the USA; 11 numeric characters for the UK). Likewise, if an entered text string is short (e.g. less than or equal to 2 characters) the large number of corresponding predictive text candidates may be too large to allow a meaningful selection of a subset for presentation.

A text string may comprise a series of one or more characters in a particular order. A character may comprise a combination of one or more of a word, a letter character (e.g. from the Roman, Greek, Arabic or Cyrillic alphabets), a graphic character (e.g. a sinograph, Japanese kana or Korean delineation), a phrase, a syllable, a diacritical mark, an emoticon, and a punctuation mark. A text string may comprise a combination of one or more of: a word; a sentence; a phrase; an affix; a prefix and a suffix. A text string may include a series of letters/characters which can be used to transcribe, for example, Chinese (e.g. Pinyin, Zhuyin Fuhao). That is, the apparatus may be configured to enable input of Chinese or Japanese characters, either directly or via transcription methods such as Pinyin and/or Zhuyin Fuhao.

A text string may be recognised by the apparatus/electronic device using one or more delimiters (e.g. spaces, punctuation marks, capital letters, tab character, return character, or another control character), the delimiters being associated with the beginning and/or end of the text string. The presentation of control elements may be based on the most recently entered text string (e.g. the last entered word/partial word; last entered sentence/partial sentence; last entered pinyin syllable/partial syllable). The presentation of control elements may be based on the whole entered text string.

The entered text string may form part of, for example, a text message, an SMS message, an MMS message, an email, a search entry, a text document, a phone number, a twitter post, a status update, a blog post, a calendar entry and a web address.

A keyboard or keypad for text entry may comprise, for example, an alphanumeric key input area, alphabetic key input area, a numeric key input area, an AZERTY key input area, a QWERTY key input area or an ITU-T E.161 key input area.

The determination of whether to enable presentation of the control elements may depend on the type of text entry field. For example different criteria may be used when the text entry field is part of a form than when the text entry field is a large document.

The apparatus may be configured to enable the presentation of the control elements based on detecting that the entered text string is a complete word. The detecting that the entered text string is a complete word may be performed by comparing the entered text string with words stored in a predicative text dictionary. The detecting that the entered text string is a complete word may be performed by detecting entry of a punctuation mark character. The detection that the entered text string is a complete word may be performed by the apparatus. Alternatively/in addition the apparatus may be configured to enable the presentation of the control elements based on detecting that the entered string is at least one of, for example, a complete sentence, a complete syllable and a complete paragraph (wherein the detection may or may not be carried out by the apparatus).

The apparatus may be configured to enable the presentation of the control elements in an area associated with the provision of predictive text candidates. For example, the control elements may be presented in the place of predictive text candidates (i.e. where predictive text candidates have previously been presented).

The apparatus may be configured to enable the presentation of predictive text candidates in an area associated with the provision of the control elements when the entered text string is an incomplete word. The position of the area associated with the provision of the control elements and/or predictive text candidates may be defined with respect to the graphical user interface (e.g. the top left of the display), or with respect to the text cursor (e.g. below the text cursor) and may be demarked accordingly. The text cursor may indicate the position where text is to be entered.

The apparatus may be configured to enable the presentation of the control elements based on whether the number of available predictive text candidates for the entered text string meets predetermined criteria. The predetermined criteria may include that the number of predictive text candidates be lower than a predetermined threshold (e.g. so that even when the one or more predictive text candidates is displayed there is still room for one or more control elements). The predetermined criteria may include that the number of predictive text candidates be greater than a predetermined threshold. For example, there may be so many predictive text candidates that selecting a subset for presentation may not be helpful.

The apparatus may be configured to enable the presentation of the control elements based on available space for predictive text candidates and the space taken up by available predictive text candidates for the entered text string.

At least one control element may be configured to be selectable to actuate an associated function performable using an electronic device.

At least one control element may be configured to:
send a textual message;
insert current location;
attach a file;
insert an emoticon;
insert a predetermined text string;
associate a hyperlink with the entered text string; or
format the entered text.

It will be appreciated that these examples of control elements may be considered to be non-predictive-text functions. That is, a non-predictive-text function may be considered to be any function which is not concerned with altering the entered text string. Predictive-text functions may be considered to include functions which are used to change the series of one or more characters making up the entered text string (e.g. the characters making up the text string on which the presentation of control elements was based). Such functions may include appending one or more characters to the entered text string (e.g. adding ‘ing’ to ‘interest’ to make ‘interesting’), removing/deleting characters from the entered text string, replacing one or more characters in a text string (e.g. replacing ‘recwive’ with ‘receive’), disambiguating ambiguous text entry (e.g. replacing the character string ‘book’ with ‘cool’ because they share the same ambiguous key sequence ‘2665’ when entered using a standard ITU-T E.161 keypad; or entering a Chinese character when the pinyin equivalent has been entered).

At least one control element may be one of an icon, a virtual key, and a menu item.

A control element may comprise an indicator configured to indicate the availability of one or more further control elements.

The apparatus may comprise the graphical user interface configured to provide the control elements as display outputs.

The apparatus may be a portable electronic device, a laptop computer, a mobile phone, a Smartphone, a tablet computer, a personal digital assistant, a digital camera, a watch, a server, a non-portable electronic device, a desktop computer, a monitor, a server, a wand, a pointing stick, a touchpad, a touch-screen, a mouse, a joystick or a module/circuitry for one or more of the same.

According to a further aspect, there is provided a method, the method comprising:
enabling presentation of control elements on a graphical user interface during text entry based on a text string entered into a text entry field, the control elements being associated with non-predictive-text functions.

According to a further aspect, there is provided a computer program comprising computer program code, the computer program code being configured to perform at least the following:
enable presentation of control elements on a graphical user interface during text entry based on a text string entered into a text entry field, the control elements being associated with non-predictive-text functions.

According to a further aspect, there is provided an apparatus comprising:
an enabler configured to enable presentation of control elements on a graphical user interface during text entry based on a text string entered into a text entry field, the control elements being associated with non-predictive-text functions.

According to a further aspect there is provided an apparatus comprising:
means for enabling configured to enable presentation of control elements on a graphical user interface during text entry based on a text string entered into a text entry field, the control elements being associated with non-predictive-text functions.

The steps of any method disclosed herein do not have to be performed in the exact order disclosed, unless explicitly stated or understood by the skilled person.

Corresponding computer programs (which may or may not be recorded on a carrier, such as a CD or other non-transitory medium) for implementing one or more of the methods disclosed herein are also within the present disclosure and encompassed by one or more of the described example embodiments.

The present disclosure includes one or more corresponding aspects, example embodiments or features in isolation or in various combinations whether or not specifically stated (including claimed) in that combination or in isolation. Corresponding means and corresponding function units (e.g. a generator, a constructer) for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:—

FIG. 1 depicts an example apparatus embodiment according to the present disclosure comprising a number of electronic components, including memory and a processor;

FIG. 2 depicts an example apparatus embodiment according to the present disclosure comprising a number of electronic components, including memory, a processor and a communication unit;

FIG. 3 depicts an example apparatus embodiment according to the present disclosure comprising a number of electronic components, including memory, a processor and a communication unit;

FIGS. 4a-4b illustrate an example apparatus according to the present disclosure in communication with a remote server/cloud;

FIGS. 5a-d show an example embodiment configured to enable predictive text entry;

FIGS. 6a-c depict a further example embodiment configured to enable predictive text entry;

FIGS. 7a-b show a further example embodiment wherein a user is creating a calendar entry;

FIG. 8 shows the main steps of a method of presenting control elements based on an entered text string; and

FIG. 9 a computer-readable medium comprising a computer program.

### DESCRIPTION OF EXAMPLE ASPECTS/EMBODIMENTS

It is common for an electronic device to have a user interface (which may or may not be graphically based) to allow a user to interact with the device to enter and/or interact with information. For example, the user may use a keyboard user interface to enter text, or icons to open applications.

For some devices such as small devices, there are competing factors in providing as many user interface elements as possible (e.g. to increase the functionality available to the user), and ensuring that the overall size of the user interface element array does not take up too much space.

Taking character entry as an example, graphical user interfaces may provide a keyboard configured to enable a user to enter characters into a separate text entry field. In addition, there is generally provided a number of user interface elements to enable the user to control the device (e.g. to send the message, attach a file, or to navigate away from the text entry field). Each of these components occupies space which may result in a cluttered user interface.

Example embodiments disclosed herein relate to enabling presentation of control elements on a graphical user interface during text entry based on a text string entered into a text entry field, the control elements being associated with non-predictive-text functions. This may allow the graphical user interface to be dedicated to text entry when the control elements are not required. This may result in a less cluttered and a more intuitive user interface. It may also allow the user to access the functions he needs with fewer interactions (e.g. without having to navigate a menu structure).

Other example embodiments depicted in the figures have been provided with reference numerals that correspond to similar features of earlier described example embodiments. For example, feature number 1 can also correspond to numbers 101, 201, 301 etc. These numbered features may appear in the figures but may not have been directly referred to within the description of these particular example embodiments. These have still been provided in the figures to aid understanding of the further example embodiments, particularly in relation to the features of similar earlier described example embodiments.

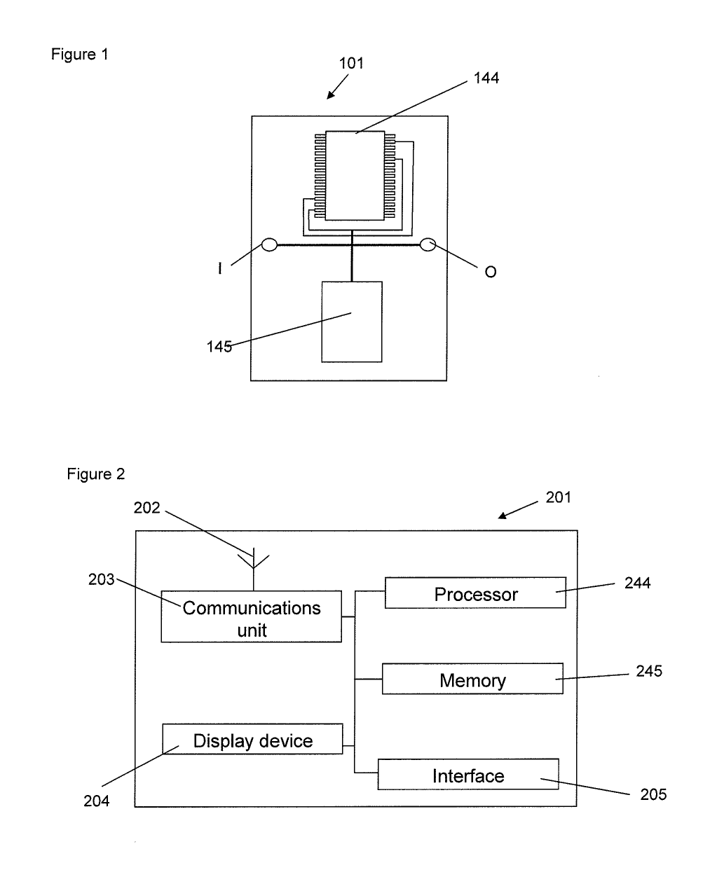

FIG. 1 shows an apparatus 101 comprising memory 145, a processor 144, input I and output O. In this example embodiment only one processor and one memory are shown but it will be appreciated that other example embodiments may utilise more than one processor and/or more than one memory (e.g. same or different processor/memory types). This apparatus may be used for generating payload data for transmission and/or constructing data items from received data payload items.

In this example embodiment the apparatus 101 is an Application Specific Integrated Circuit (ASIC) for a portable electronic device. In other example embodiments the apparatus 101 can be a module for such a device, or may be the device itself, wherein the processor 144 is a general purpose CPU of the device and the memory 145 is general purpose memory comprised by the device.

The input I allows for receipt of signalling to the apparatus 101 from further components, such as components of a portable electronic device (like a touch-sensitive display or a receiver) or the like. The output O allows for onward provision of signalling from within the apparatus 101 to further components. In this example embodiment the input I and output O are part of a connection bus that allows for connection of the apparatus 101 to further components (e.g. to a transmitter or a display).

The processor 144 is a general purpose processor dedicated to executing/processing information received via the input I in accordance with instructions stored in the form of computer program code on the memory 145. The output signalling generated by such operations from the processor 144 is provided onwards to further components via the output O.

The memory 145 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 144, when the program code is run on the processor 144. The internal connections between the memory 145 and the processor 144 can be understood to, in one or more example embodiments, provide an active coupling between the processor 144 and the memory 145 to allow the processor 144 to access the computer program code stored on the memory 145.

In this example the input I, output O, processor 144 and memory 145 are all electrically connected to one another internally to allow for electrical communication between the respective components I, 0, 144, 145. In this example the components are all located proximate to one another so as to be formed together as an ASIC, in other words, so as to be integrated together as a single chip/circuit that can be installed into an electronic device. In other examples one or more or all of the components may be located separately from one another.

FIG. 2 depicts an apparatus 201 of a further example embodiment, such as a mobile phone. In other example embodiments, the apparatus 201 may comprise a module for a mobile phone (or PDA or audio/video player), and may just comprise a suitably configured memory 245 and processor 244. The apparatus in certain example embodiments could be a portable electronic device, a laptop computer, a mobile phone, a Smartphone, a tablet computer, a personal digital assistant, a digital camera, a watch, a server, a non-portable electronic device, a desktop computer, a monitor, a server, a wand, a pointing stick, a touchpad, a touch-screen, a mouse, a joystick or a module/circuitry for one or more of the same.

The example embodiment of FIG. 2, in this case, comprises a display device 204 such as, for example, a Liquid Crystal Display (LCD) or touch-screen user interface. The apparatus 201 of FIG. 2 is configured such that it may receive, include, and/or otherwise access data. For example, this example embodiment 201 comprises a communications unit 203, such as a receiver, transmitter, and/or transceiver, in communication with an antenna 202 for connecting to a wireless network and/or a port (not shown) for accepting a physical connection to a network, such that data may be received via one or more types of networks. This example embodiment comprises a memory 245 that stores data, possibly after being received via antenna 202 or port or after being generated at the user interface 205. The processor 244 may receive data from the user interface 205, from the memory 245, or from the communication unit 203. It will be appreciated that, in certain example embodiments, the display device 204 may incorporate the user interface 205. Regardless of the origin of the data, these data may be outputted to a user of apparatus 201 via the display device 204, and/or any other output devices provided with apparatus. The processor 244 may also store the data for later use in the memory 245. The memory 245 may store computer program code and/or applications which may be used to instruct/enable the processor 244 to perform functions (e.g. read, write, delete, edit or process data).

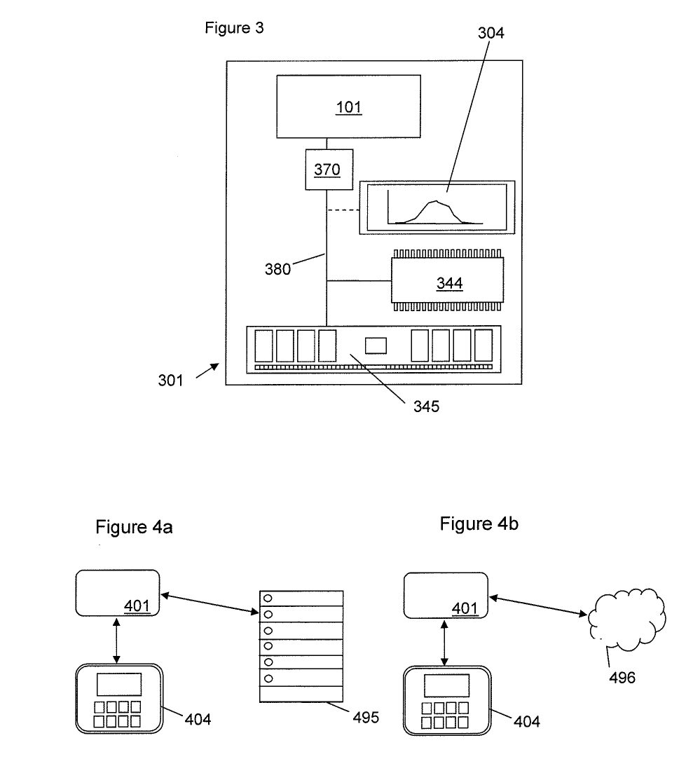

FIG. 3 depicts a further example embodiment of an electronic device 301, such as a tablet personal computer, a portable electronic device, a portable telecommunications device, a server or a module for such a device, the device comprising the apparatus 101 of FIG. 1. The apparatus 101 can be provided as a module for device 301, or even as a processor/memory for the device 301 or a processor/memory for a module for such a device 301. The device 301 comprises a processor 344 and a storage medium 345, which are connected (e.g. electrically and/or wirelessly) by a data bus 380. This data bus 380 can provide an active coupling between the processor 344 and the storage medium 345 to allow the processor 344 to access the computer program code. It will be appreciated that the components (e.g. memory, processor) of the device/apparatus may be linked via cloud computing architecture. For example, the storage device may be a remote server accessed via the internet by the processor.

The apparatus 101 in FIG. 3 is connected (e.g. electrically and/or wirelessly) to an input/output interface 370 that receives the output from the apparatus 101 and transmits this to the device 301 via data bus 380. Interface 370 can be connected via the data bus 380 to a display 304 (touch-sensitive or otherwise) that provides information from the apparatus 101 to a user. Display 304 can be part of the device 301 or can be separate. The device 301 also comprises a processor 344 configured for general control of the apparatus 101 as well as the device 301 by providing signalling to, and receiving signalling from, other device components to manage their operation.

The storage medium 345 is configured to store computer code configured to perform, control or enable the operation of the apparatus 101. The storage medium 345 may be configured to store settings for the other device components. The processor 344 may access the storage medium 345 to retrieve the component settings in order to manage the operation of the other device components. The storage medium 345 may be a temporary storage medium such as a volatile random access memory. The storage medium 345 may also be a permanent storage medium such as a hard disk drive, a flash memory, a remote server (such as cloud storage) or a non-volatile random access memory. The storage medium 345 could be composed of different combinations of the same or different memory types.

FIG. 4a shows that an example embodiment of an apparatus in communication with a remote server. FIG. 4b shows that an example embodiment of an apparatus in communication with a “cloud” for cloud computing. In FIGS. 4a and 4b, apparatus 401 (which may be apparatus 101, 201 or 301 is in communication with a display 404). Of course, the apparatus 401 and display 404 may form part of the same apparatus/device, although they may be separate as shown in the figures. The apparatus 401 is also in communication with a remote computing element. Such communication may be via a communications unit, for example. FIG. 4a shows the remote computing element to be a remote server 495, with which the apparatus may be in wired or wireless communication (e.g. via the internet, Bluetooth, a USB connection, or any other suitable connection as known to one skilled in the art). In FIG. 4b, the apparatus 401 is in communication with a remote cloud 496 (which may, for example, by the Internet, or a system of remote computers configured for cloud computing). It may be that the functions associated with the user interface elements are stored at the remote computing element 495, 496) and accessed by the apparatus 401 for display 404. The enabling presentation of control elements, for example may be performed at the remote computing element 495, 496. The apparatus 401 may actually form part of the remote sever 495 or remote cloud 496.

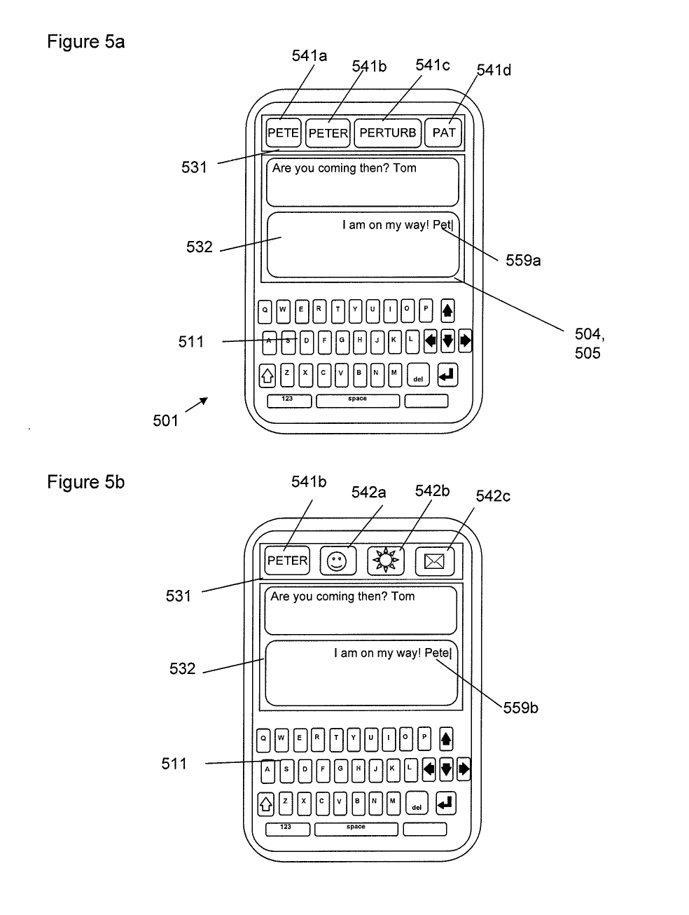

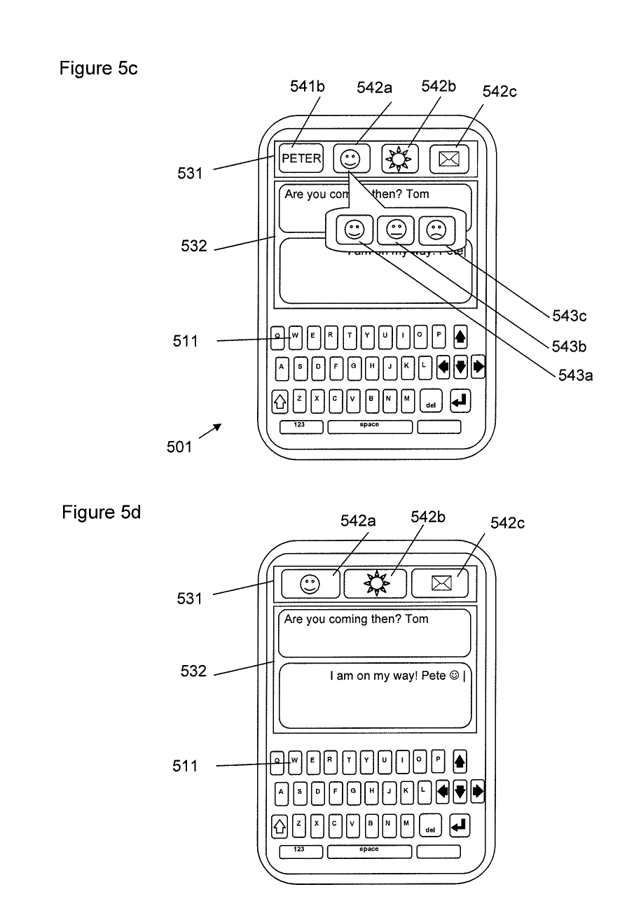

FIGS. 5a-5d illustrate a series of views of an example embodiment 501 of FIG. 2 when in use. In this case, the example embodiment is a portable electronic device such as a mobile phone. In this example, the user wants to reply to his friend Tom by composing a message and sending it, via a network (e.g. mobile phone network, internet, LAN or Ethernet).

To facilitate the inputting such a message, the electronic device 501 has a physical keyboard 511 and a touch screen display 504, 505. When the user is composing a message the display 504, 505 is configured to display an entered character region 532 and a predictive text candidate region 531. The entered character region 532 of the touch-screen user interface is configured to display the arrangement of the characters, or text strings, already input into the device (e.g. via the keyboard 511 and/or predictive text candidate region 531). In the situation shown in FIG. 5a, the user has already entered the text “I am on my way! Pet”. That is, he is in the processes of entering his name, which is ‘Pete’. In this case, the device/apparatus is configured to present the control elements based on the most recently entered word/partial word text string.

In FIG. 5a, the user has typed in the text string ‘Pet’ 539a using the keys of the physical keyboard. For this example embodiment, characters which are input using the keyboard 511 are entered directly into the entered character region 532 as the characters are typed.

The apparatus is then configured to determine one or more predictive text candidates based on the entered text string 539a (e.g. ‘Pete’, ‘Peter’ and ‘Perturb’ and ‘Pat’ as shown in FIG. 5a). It will be appreciated that the predictive text candidates 541a-d may comprise the entered text string (e.g. ‘Pete’), or that a portion of the predictive text candidates may be similar to the entered text string (e.g. Perturb) to allow for spelling mistakes. It will be appreciated that other example embodiments may be configured to provide text candidates which are partial text strings which can be appended to the end of an entered text string to make up a full word (e.g. the partial text string ‘er’, which can be appended to ‘Pet’ to make up the word ‘Peter’).

The determined predictive text candidates 541a-541d are then displayed in a predictive text region shown at the top of the display. In this case, the user wishes to enter the word Pete so selects the ‘Pete’ predictive text candidate 541a.

When the user has selected the ‘Pete’ predictive text candidate 541a, the corresponding text string 559b is entered into the entered character region of the display. The apparatus/device is configured to determine that the entered text string 559b is a complete word and, based on this determination, enable presentation of control elements 542a-542c on the display graphical user interface 504, 505 during text entry, the control elements 542a-542c being associated with non-predictive-text functions. In this case, the control elements correspond with the functions of: entering an emoticon 542a; converting the entered text string to a hyperlink 542b; and sending the message 542c. By presenting the control elements in the predictive text candidates bar 531, control elements are presented in an area associated with the provision of predictive text candidates. Although the entered text string ‘Pete’ is a complete word, there are other words in the predictive text dictionary which comprise the entered text string and one or more additional characters. In this case, there is one such candidate ‘Peter’ 541b which is displayed in the predictive text candidate bar 531 in addition to the control elements.

In this case, the user wants to enter an emoticon, so he selects the emoticon control element 542a, which in this case is an indicator configured to indicate the availability of other control elements. Selecting the emoticon control element brings up a list of three selectable emoticons 543a-c. The user selects the smiley emoticon 543a which is entered into the entered character region of the display.

When the user has added the emoticon by selecting it from the list, there are no predictive text candidates which comprise the entered text string and one or more additional characters. Therefore, in the situation depicted in FIG. 5d, there are no predictive text candidates shown in the predictive text region 531. In this case, rather than present more control elements, the existing control elements are enlarged to occupy the space previously taken up by the predictive text candidate. In this way, the control elements are presented in an area associated with the provision of predictive text candidates. At this point, the user wishes to send the message and so presses the send message control element 542c. This then sends the message to his friend Tom.

In this example embodiment, the control elements are shown when the entered text string corresponds to a complete word. It will be appreciated that other example embodiments may be configured to enable the presentation of the control elements based on whether the number of available predictive text candidates for the entered text string meets predetermined criteria. For example, the device/apparatus may be configured to present the control elements if the number of predictive text candidates is below a predetermined threshold (e.g. three or four). Other example embodiments may take into account the length of the predictive text candidates. For example, an example embodiment may enable the presentation of the control elements based on available space for predictive text candidates and the space taken up my available predictive text candidates for the entered text string. For example, if the width of the predictive text region is 5 cm and the predictive text candidates for a particular text string occupied 3 cm, the apparatus/device may be configured to utilise at least some of the remaining 2 cm for presenting control elements. It will be appreciated that other example embodiments may be configured to adjust space usage within the predictive text region based on the length of the currently presented predictive text candidates to, for example, maintain a minimum number of predictive text candidates (e.g. two or three).

In this case, the example embodiment is configured to present the control elements in response to detecting a complete word. Other example embodiments may be configured to detect the entry of a complete message (E.g. “OK, I'll see you soon”) or a predetermined end to a message (e.g. the user's name, or standard sign off, such as, ‘yours sincerely, Mike’)

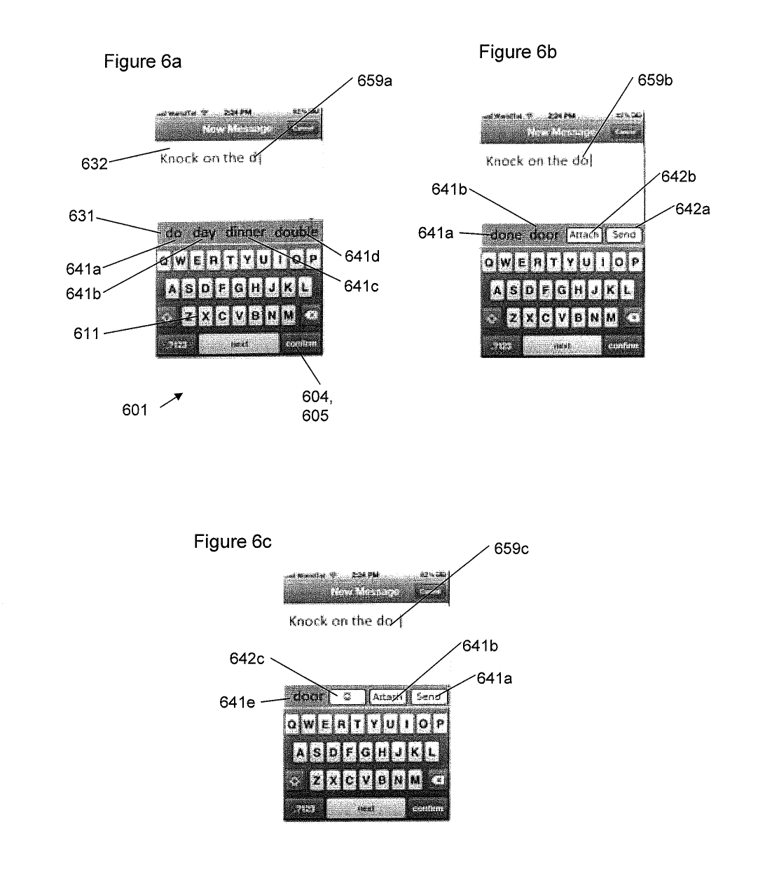

FIGS. 6a-6c illustrate a series of views of an further example embodiment 601 of FIG. 2 which, in this case, is a portable electronic device. In this example, the user wants to enter the text “Knock on the door” and send it as an SMS message. It will be appreciated that in other examples, the entered text may form part of, for example, a text message, an email, a search entry, a status update, a twitter post, a blog post, a calendar entry or a web address.

To facilitate the inputting such a message, this example embodiment has a display comprising a virtual keyboard 611, a predictive text region 631 and a text entry field 632. The text entry field 632 of the touch-screen user interface 604, 605 is configured to display the arrangement of the characters, or text strings, already input into the device (e.g. via the keyboard and/or selection region). In the situation shown in FIG. 6a, the user has already entered the text ‘Knock on the d’. That is, he is in the processes of entering the last text string 659a, which will form part of the complete word string ‘door’.

In FIG. 6a, the user has typed in the text string ‘d’ 659a using the keys of the virtual keyboard 511. For this example embodiment, characters that are input using the keyboard 511 are entered directly into the entered character region 632 as the characters are typed.

The apparatus is then configured to determine one or more predictive text candidates based on the entered text string (e.g. ‘do’, ‘day’ and ‘dinner’ and ‘double’ as shown in FIG. 6a). It will be appreciated that the predictive text candidates may comprise the entered text string.

The determined predictive text candidates 641a-641d are then displayed in the predictive text region 631. Although the displayed predictive text candidate ‘do’ 641a forms part of the desired complete word string ‘door’, the user continues to enter text using the virtual keyboard 611 to reduce the number of candidates. In the situation depicted in FIG. 6b the user has entered an additional ‘o’ character such that the entered text string is ‘do’ 659b. When the user has changed the entered text string, the apparatus/device is configured to determine predictive text strings based on the new entered text string 459b and display them in the predictive text region. In this case, the device/apparatus has determined two predictive text candidates: ‘done’ 641a and ‘door’ 641b.

In this example embodiment, because the predictive text candidates 641a-641b do not fill the entire predictive text region 631, the apparatus/device is configured to use the remaining space to provide control elements 642a, 642b, the control elements being associated with non-predictive-text functions. In this case the control elements 642a-642b correspond to attaching a file (e.g. a photo), and sending the message. In this way, the apparatus/device is configured to enable presentation of control elements on a graphical user interface during text entry based on a text string entered into a text entry field, the control elements being associated with non-predictive-text functions. In particular, the apparatus/device is configured to dynamically modify how the space of the predictive text region is allocated between predictive text candidates and control elements based on the text string entered into a text entry field.

The user then inadvertently enters a space character. As the entered text string is a complete word string, the device is configured to display a limited number of predictive text candidates, in this case a maximum of one predictive text candidate (in certain example embodiments no candidates may be provided as the entry of a word may be considered to be complete). As shown in FIG. 6c, for the entered text string ‘do’, the apparatus is configured to display the predictive text candidate ‘door’. The rest of the predictive text region is devoted to control elements. In this case, in addition to the send and attach control elements, the apparatus/device is configured to present an emoticon control element. In this case, the apparatus is configured to detect that the entered text string is a complete word by detecting entry of a punctuation mark character. In this case, the punctuation mark character is a space character. Other punctuation mark characters which may denote the end of a word string might include full stops, commas, question marks and exclamation marks.

It will be appreciated that other example embodiments may be configured to calculate a probability that the entered text string is the complete string desired by the user. For example, the probability calculation may be based on the number of predictive text candidates corresponding to the entered text string and/or the number of characters making up the entered text string. For example, the text string ‘do’ is associated with the predictive text candidates ‘done’ and ‘door’, and so has a lower probability of being the desired text string than ‘door’ which has no corresponding predictive text candidates (and is also longer). In addition/alternatively, the probability calculation may take into account the word sequence before the entered text string to determine, for example, the context and type of word which the desired word should be. In this case, the preceding word character string is ‘the’ which suggests that the desired text string may be a noun (e.g. door) rather than a verb (e.g. ‘do’).

In this case, the user can select the desired predictive text candidate 641e from the predictive text region 631 which is then entered into the text entry field 632. Then the user can select the send control element 641a to send the text message.

It will be appreciated that instead of sending the message, if the user continues to enter a new text string, the apparatus/device/server would be configured to enable the presentation of predictive text candidates in an area associated with the provision of the control elements when the entered text string is an incomplete word. For example, if the user entered the text string ‘pie’ (as part of the word string ‘please’), the apparatus/device/server may be configured to determine and enable display of the predictive text candidates ‘plea’, ‘pleas’, ‘please’ and ‘pleasant’. In this way, the device is configured to display predictive text candidates when the word string is an incomplete word string, and control elements when the entered string is a complete word string. In this way, the control elements are presented when the user may need them (i.e. when they have finished a word), but not presented when the user may not require them (i.e. when the user is in the process of entering a word).

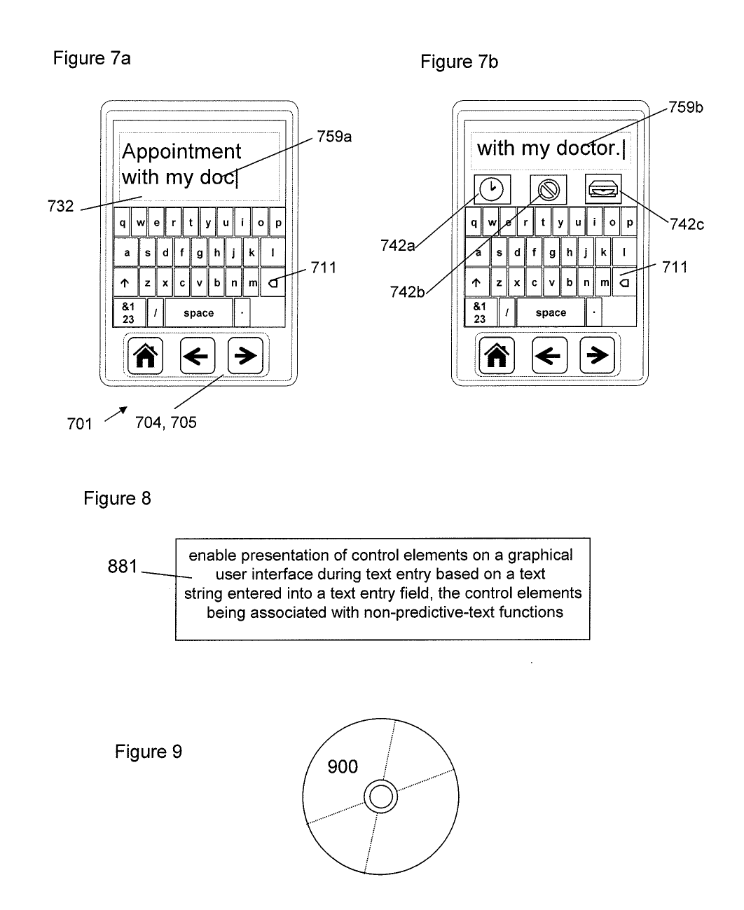

FIGS. 7a-7b illustrate a series of views of an example embodiment of FIG. 2 which in this case is a Personal Digital Assistant (PDA). In this example, the user wants to add a calendar entry to a calendar application for a doctor's appointment. In particular, the user wishes to enter the text “Appointment with my doctor.”

To facilitate the inputting such a reminder, this example embodiment has a display 704, 705 comprising a virtual keyboard 711, and a text entry field 732. The text entry field 732 of the touch-screen user interface 704, 705 is configured to display the arrangement of the characters, or text strings, already input into the device (e.g. via the keyboard). In the situation shown in FIG. 7a, the user has already entered the text ‘Appointment with my doc’. That is, he is in the processes of entering the last text string, which is the word string ‘doctor’. In FIG. 7a, the user has typed in the text string ‘doc’ 759a using the keys of the virtual keyboard 511.

Unlike the previous example embodiments, this example embodiment is not configured to provide predictive text candidates. The user therefore continues to enter characters until he has entered the complete word followed by a full stop punctuation mark.

When the user has entered the full stop punctuation mark, the device/apparatus is configured to recognise that a complete word has been entered. In response to detecting that a complete word has been entered, the device/apparatus is configured to enable presentation of control elements 742a-742c on the graphical user interface. In this case, control elements 742a-742c are positioned over a portion of the text entry field. In this case, this reduces the size of the text entry field so only the last line of the entered text can be seen. This is shown in FIG. 7b. The control elements 742a-742c in this case comprise control elements corresponding to the functions ‘set time’ 742a, which allows the user to set the time of the appointment; ‘cancel’ 742b, which allows the user to delete the created calendar entry; and ‘save calendar entry’ 742c, which allows the user to save the created calendar entry. It will be appreciated that in other example embodiments other control elements may be presented. For example, other example embodiments may be configured to present editing functions (e.g. embolden, underline, italicize, change font) based on the entered text string (e.g. when a complete word is detected).

In this case, the user is happy with the calendar entry and so selects the ‘save calendar entry’ control element. This saves the calendar entry and exits the text entry display. It will be appreciated that if the user had continued to enter text into the text entry field, the apparatus would have hidden the control elements (e.g. based on the most recently entered text string being an incomplete word). This may allow the space dedicated to showing the entered text to be maximised when the user is in the process of entering a word.

In the above cases, the position of the area associated with the provision of the control elements and/or predictive text candidates is defined with respect to the graphical user interface. For example, in the example embodiment of FIG. 5a-d, the predictive text region is at the top of the display. It will be appreciated that for other example embodiments, the area associated with the presentation of the control elements and/or predictive text candidates may be defined with respect to the text cursor. For example, the apparatus may be configured to present the control elements in a pop-up menu displayed above the text cursor.

In the above cases, the control elements and/or predictive text candidates have been selectable using a touch screen. It will be appreciated that other example embodiments may allow other methods of selecting and interacting with the user interface elements (such as the control elements). For example, the control elements may be selectable by using a cursor and mouse or touchpad, or by using a wand.

FIG. 8 illustrates the process flow according to an example embodiment of the present disclosure. The process comprises enabling 881 the presentation of control elements on a graphical user interface during text entry based on a text string entered into a text entry field, the control elements being associated with non-predictive-text functions.

FIG. 9 illustrates schematically a computer/processor readable medium 900 providing a computer program according to one example embodiment. In this example, the computer/processor readable medium 900 is a disc such as a digital versatile disc (DVD) or a compact disc (CD). In other example embodiments, the computer/processor readable medium 1155 may be any medium that has been programmed in such a way as to carry out an inventive function. The computer/processor readable medium 900 may be a removable memory device such as a memory stick or memory card (SD, mini SD or micro SD).

It will be appreciated to the skilled reader that any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some example embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such example embodiments can include a reduced requirement to download data when further functionality is required for a device, and this can be useful in examples where a device is perceived to have sufficient capacity to store such pre-programmed software for functionality that may not be enabled by a user.

It will be appreciated that any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some example embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed example embodiments may consist of any such individual feature or combination of features. In view of the foregoing description it will be evident to a person skilled in the art that various modifications may be made within the scope of the disclosure.

While there have been shown and described and pointed out fundamental novel features as applied to different embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured, with the at least one processor, to cause the apparatus to perform at least the following:
enable presentation of control elements on a graphical user interface during text entry based on a text string entered into a text entry field, the control elements being associated with non-predictive-text functions.

2. The apparatus of claim 1, wherein the apparatus is configured to enable the presentation of the control elements based on detecting that the entered text string is a complete word.

3. The apparatus of claim 2, wherein the detecting that the entered text string is a complete word is performed by comparing the entered text string with words stored in a predicative text dictionary.

4. The apparatus of claim 2, wherein the detecting that the entered text string is a complete word is performed by detecting entry of a punctuation mark character.

5. The apparatus of claim 2, wherein the detection that the entered text string is a complete word is performed by the apparatus.

6. The apparatus of claim 1, wherein the apparatus is configured to enable the presentation of the control elements in an area associated with the provision of predictive text candidates.

7. The apparatus of claim 1, wherein the apparatus is configured to enable the presentation of predictive text candidates in an area associated with the provision of the control elements when the entered text string is an incomplete word.

8. The apparatus of claim 1, wherein the apparatus is configured to enable the presentation of the control elements based on whether the number of available predictive text candidates for the entered text string meets predetermined criteria.

9. The apparatus of claim 1, wherein the apparatus is configured to enable the presentation of the control elements based on available space for predictive text candidates and the space taken up by available predictive text candidates for the entered text string.

10. The apparatus of claim 1, wherein at least one control element is configured to be selectable to actuate an associated function performable using an electronic device.

11. The apparatus of claim 1, wherein at least one control element is configured to:
send a textual message;
insert current location;
attach a file;
insert an emoticon;
insert a predetermined text string;
associate a hyperlink with the entered text string; or
format the entered text.

12. The apparatus of claim 1, wherein at least one control element is one of an icon, a virtual key, and a menu item.

13. The apparatus of claim 1, wherein the apparatus comprises the graphical user interface configured to provide the control elements as display outputs.

14. The apparatus of claim 1, wherein the apparatus is a portable electronic device, a laptop computer, a mobile phone, a Smartphone, a tablet computer, a personal digital assistant, a digital camera, a watch, a server, a non-portable electronic device, a desktop computer, a monitor, a server, a wand, a pointing stick, a touchpad, a touch-screen, a mouse, a joystick or a module/circuitry for one or more of the same.

15. A method, the method comprising:
enabling presentation of control elements on a graphical user interface during text entry based on a text string entered into a text entry field, the control elements being associated with non-predictive-text functions.

16. A computer program comprising computer program code, the computer program code being configured to perform at least the following:
enable presentation of control elements on a graphical user interface during text entry based on a text string entered into a text entry field, the control elements being associated with non-predictive-text functions.
